(19) United States
(12) Patent Application Publication
(10) Pub. No.: US 2024/0191409 A1
(43) Pub. Date: Jun. 13, 2024

(54) RECYCLABLE LINER, PANEL, OR COMPONENT

(71) Applicant: Piana Nonwovens, LLC., Cartersville, GA (US)

(72) Inventors: Eric McCann, Cartersville, GA (US); Andy Hollis, Cartersville, GA (US); Michael Stephen DeFranks, Cartersville, GA (US); Sang-hoon Lim, Cartersville, GA (US); Yang Yu, Cartersville, GA (US); Andrea Piana, Cartersville, GA (US); Ariel Guerra, Cartersville, GA (US)

(21) Appl. No.: 18/530,297

(22) Filed: Dec. 6, 2023

Related U.S. Application Data
(60) Provisional application No. 63/431,204, filed on Dec. 8, 2022.
(60) Provisional application No. 63/431,229, filed on Dec. 8, 2022.

(51) Int. Cl. D04H 1/74; B29C 33/72; B29C 43/20; B29C 43/32; B29C 43/52; B32B 1/00; B32B 5/02; B32B 5/26; B32B 27/12; B32B 27/36; D04H 1/435; D04H 1/44

(52) U.S. Cl. CPC D04H 1/74; B29C 33/72; B29C 43/203; B29C 43/32; B29C 43/52; B32B 1/00; B32B 5/022; B32B 5/026; B32B 5/266; B32B 27/12; B32B 27/36; D04H 1/435; D04H 1/44; B29K 2067/00; B32B 2262/0276; B32B 2605/003; D10B 2401/00

(57) ABSTRACT

Provided are recyclable liner, panel or components which contain a vertically lapped polymer material constructed from at least vertically lapped first polymer fibers, wherein the vertically lapped polymer material includes a first surface and a second surface; and optionally at least one sheet of a same polymer or a compatible polymer to the vertically lapped first polymer fibers adhered to at least one of the first surface and the second surface of the vertically lapped polymer material. At least one of the first surface and the second surface of the vertically lapped polymer material is molded to include one or more structural features that project from the first surface and/or the second surface so that the vertically lapped polymer material with the adhered sheet has a three dimensional configuration. Methods for manufacturing the recyclable liner, panel or components are also provided.

### CROSS-REFERENCE TO RELATED APPLICATIONS

This application claims priority to U.S. Provisional Application 63/431,204 filed on Dec. 8, 2022 and U.S. Provisional Application 63/431,229 filed on Dec. 8, 2022. The complete content thereof is herein incorporated by reference.

### FIELD OF THE INVENTION

The disclosure generally pertains to vertically lapped (perpendicular-laid) nonwoven materials that enable recyclability of various vehicle components. The surface of the vehicle component that is exposed to vehicle occupants may be void of a traditional textile or common industry covering, but instead exposes the nonwoven material itself which may have its surface textured or altered as described herein.

### BACKGROUND

On Oct. 21, 2000, the EU Directive on end-of-life vehicles (ELVs) went into force. A new revised directive was proposed on Jul. 13, 2023. The aim of the directive is to set out measures to prevent and limit waste from ELVs and their components by ensuring their reuse, recycling, and recovery.

The key points of the directive require vehicle and equipment manufacturers to factor in the dismantling, reuse and recovery of the vehicles when designing and producing their products, ensuring that new vehicles are: i) reusable and/or recyclable to a minimum of 85% by weight per vehicle and ii) reusable and/or recoverable to a minimum of 95% by weight per vehicle.

There are many other requirements of the directive, but a need to develop solutions for interior components such as headliners, door panels and the like exists as the current state relies upon assemblies of dissimilar materials and assembly methods that do not allow for ease of recycling. For example, common headliner substrates are often composites with fiberglass and are not by themselves esthetically pleasing or functionally viable to have exposed to the passengers. Indeed, fiberglass is itchy and small particles of it in the air are a health concern. They thus require the substrate to be covered on the A side (i.e. the side visible by the passengers) by an esthetically pleasing covering, be it a textile, a vinyl, etc. This adds even more material that would complicate recycling at the end of life of the car.

An immediate need for a single material solution to these various use-cases exists.

### SUMMARY

Embodiments of the disclosure employ the same and/or compatible materials to enable ready recyclability. The use of such materials solves the recycling problem for headliners, door panels, and other similar components with a solution that uses only one material (or compatible materials) while meeting the various performance and aesthetic requirements that are expected in today's vehicle standards. Further, the surface of the substrate facing the vehicle passengers is void of fiberglass and is esthetically pleasing without the need for a covering.

One aspect of the disclosure provides a recyclable liner, panel or component, comprising a vertically lapped polymer material constructed from at least vertically lapped first polymer fibers, wherein the vertically lapped polymer material comprises a first surface and a second surface; and optionally at least one sheet of a same polymer or a compatible polymer to the vertically lapped first polymer fibers adjacent or adhered to at least one of the first surface and the second surface of the vertically lapped polymer material, wherein at least one of the first surface and the second surface of the vertically lapped polymer material is molded to include one or more structural features that project from the first surface and/or the second surface so that the vertically lapped polymer material with the adhered sheet has a three dimensional configuration.

In some embodiments, the vertically lapped first polymer fibers and the sheet of the same polymer or the compatible polymer are both polyesters. In some embodiments, the polyesters are the same polyester. In some embodiments, the one or more structural features are configured for attachment to another part. In some embodiments, the one or more structural features are on both the first and the second surface of the vertically lapped polymer material. In some embodiments, the three dimensional configuration forms at least part of a headliner for an automobile. In some embodiments, the headliner is a hard touch headliner.

In some embodiments, the headliner is a soft touch headliner and further comprises a second vertically lapped polymer material constructed from at least vertically lapped second polymer fibers, wherein the second vertically lapped polymer material may have an equal or lower density than the first vertically lapped polymer material and is arranged between the first vertically lapped polymer material and at least one sheet. In some embodiments, the three dimensional configuration forms at least part of an interior door for an automobile. In some embodiments, the three dimensional configuration forms at least part of an interior member of an automobile, truck, plane, train, or boat. In some embodiments, the at least one sheet is adhered to the at least one of the first surface and/or the second surface of the vertically lapped polymer material using an adhesive film, scrim, net, or web comprising the same polymer or the compatible polymer to the first polymer fibers. In some embodiments, the at least one sheet is adhered to the at least one of the first surface and the second surface of the vertically lapped polymer without an adhesive film, scrim, net, or web.

Another aspect of the disclosure provides a method of manufacturing the recyclable liner, panel, or component as described herein, comprising heating the vertically lapped polymer material and the optional at least one sheet of a same polymer or a compatible polymer; and compressing the vertically lapped polymer material and the at least one sheet of a same polymer or a compatible polymer within a mold having a first tool surface and a second tool surface, wherein at least one of the first tool surface and the second tool surface has a three dimensional configuration that is imparted on at least one of the first surface and the second surface of the vertically lapped polymer material.

In some embodiments, one or both of the first tool surface and the second tool surface are heated prior to the compressing step. In some embodiments, one or both of the first tool surface and the second tool surface are polished prior to the compressing step. In some embodiments, one or both of the first tool surface and the second tool surface are polished along a gradient from less polished to more polished prior to the compressing step. In some embodiments, one or both of the first tool surface and the second tool surface contain a repeating or non-repeating pattern. In some embodiments, the method further comprises applying heat to a portion of at least one of the first surface and the second surface of the vertically lapped polymer material after the compressing step. In some embodiments, at least one of the first tool surface and the second tool surface have different surface temperatures across the surface prior to the compressing step. In some embodiments, at least one of the vertically lapped polymer material and at least one sheet of a same polymer or a compatible polymer have mass density variations within the material or sheet. In some embodiments, the vertically lapped polymer material and the at least one sheet of a same polymer or a compatible polymer are each formed as two or more parts connectable via a three dimensional configuration before the heating step and wherein the two or more parts are connected during or after the heating step.

Additional features and advantages of the present invention will be set forth in the description of disclosure that follows, and in part will be apparent from the description of may be learned by practice of the disclosure. The disclosure will be realized and attained by the compositions and methods particularly pointed out in the written description and claims hereof.

### BRIEF DESCRIPTION OF THE DRAWINGS

FIG. 1. Image of door panel face showing structural features making a 3D configuration and polyester fabric adhered to one surface of a molded vertically lapped polymer material.

FIG. 2. Image of door panel back showing molded vertically lapped polymer material on the back of a headliner face. Some of the same and some different structural features are molded into the headliner back compared to the headliner face. The structural features may provide stiffness, designs for aesthetics, or allow for connection to components in, for example, a car roof or door, etc.

FIG. 3A. Layup of materials for a hard touch surface headliner

FIG. 3B. Layup of materials for a soft touch surface headliner.

FIG. 4. Top view of a headliner with a polyester film surface adhered to a polyester substrate, with aesthetic features (diagonals) and structural features (bottom and left edge) formed by molding.

FIG. 5. Top view of a molded polyester substrate without the polyester surface layer shown in FIG. 4. Structural elements formed in the substrate during molding and aesthetic components are shown.

FIG. 6. Bottom view of the molded polyester substrate shown in FIG. 5.

FIG. 7. Close-up view of the bottom surface of the molded polyester substrate shown in FIG. 6. The structural features are well defined by the molding process.

FIG. 8. Close-up view of the top surface of the molded polyester substrate shown in FIG. 5. This view shows the well defined structural features and aesthetic features.

FIG. 9. Close-up view of the molded component where the polyester top layer is adhered to the top surface of the substrate without an adhesive layer. The well defined structural features of the component are shown. As the entire component is polyester, it can be easily removed and recycled.

FIG. 10. Exemplary tongue and groove process for manufacturing a nonwoven part.

FIG. 11. Exemplary tongue and groove process for manufacturing a nonwoven part having a void.

FIG. 12. Alternative example of a tongue and groove configuration.

FIG. 13. Image of an example tool plate having a patterned surface on one portion and a smooth surface on another portion.

FIG. 14. Image of a soft touch headliner without a fabric layer.

FIG. 15. Image of a soft touch headliner partially covered with a fabric layer.

FIG. 16. Image of a soft touch headliner with a fabric layer.

### DETAILED DESCRIPTION

The preferred embodiments of the present disclosure are directed toward recyclable liner, panel or components that comprise the same or compatible materials which may be low odor, low fogging, low VOC materials having an inherent fire retardancy with respect to current industry safety standards. The product may include thermoplastic components rather than thermosets and composites. Further, the process for making the parts may utilize the current state of the art for manufacturing of such components (e.g., compression molding).

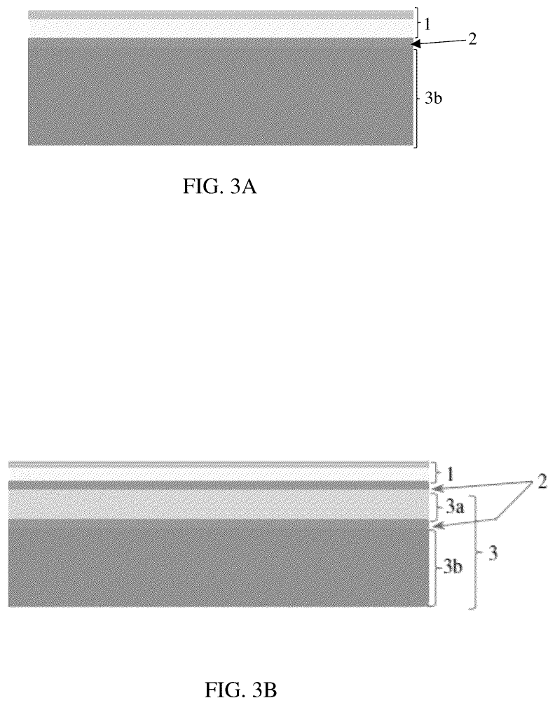

In particular, with reference to FIG. 3A, embodiments provide a recyclable liner, panel or component, comprising a vertically lapped polymer material 3b constructed from at least vertically lapped first polymer fibers, wherein the vertically lapped polymer material comprises a first surface and a second surface; and optionally at least one sheet 1 of a same polymer or a compatible polymer to the vertically lapped first polymer fibers adjacent or adhered to at least one of the first surface and the second surface of the vertically lapped polymer material, wherein at least one of the first surface and the second surface of the vertically lapped polymer material is molded to include one or more structural features that project from the first surface and/or the second surface so that the vertically lapped polymer material with the adhered sheet has a three dimensional configuration. The product optionally includes a thermoadhesive film, scrim, net, or web 2.

All or portions of the nonwoven layers disclosed herein are vertically lapped. A “nonwoven” is a manufactured sheet, web, or batt of natural and/or man-made fibers or filaments that are bonded to each other by any of several means. Manufacturing of nonwoven products is well described in “Nonwoven Textile Fabrics” in Kirk-Othmer Encyclopedia of Chemical Technology, 3rd Ed., Vol. 16, July 1984, John Wiley & Sons, p. 72.about. 124 and in “Nonwoven Textiles”, November 1988, Carolina Academic Press. Nonwovens are commercially available from a number of manufacturers.

As used herein, the term “vertically lapped” is meant that one or a plurality of materials is in the form of a web that has been folded in on itself in a corrugated fashion to produce a three-dimensional structure that has been thermally bonded and often is referred to as perpendicular laid. A “vertical lapper” is also referred to as a “STRUTO” or a “V-LAP” and some examples of machinery which may be used to make vertically lapped nonwovens for use in the invention are herein incorporated by reference (WO 2015176099 to Cooper and U.S. Pat. No. 7,591,049 to Cooper). Vertically lapped nonwovens are higher in compressional thermal resistance and lighter in weight than those made of fibers horizontally lapped, horizontally cross-lapped, horizontally woven and/or polyurethane foams. The vertically lapped nonwoven process takes a carded fiber web and laps it vertically (i.e. pleating) rather than horizontally laying the fibers. The size, shape and arrangement of the material of nonwovens may vary widely as long as nonwovens are made directly from separate fibers, molten plastic or plastic films, but not made by weaving or knitting. In an exemplary embodiment, the nonwoven is manufactured by hot-air thermal bonding using low-melt and/or elastomeric binder fibers. The binding fibers serve to mix readily with the other fibers of a nonwoven, e.g. staple fibers, and to melt on application of heat and then to re-solidify on cooling to hold the other fibers in the nonwoven together. In some applications, the binding fibers might have a core-sheath configuration where the sheath melts on application of heat and functions to hold the other fibers of the nonwoven together.

In particular, the nonwoven can have a basis weight ranging from 0.1-5.0 oz/ft²; however, the basis weight of the nonwoven can vary widely depending on the intended application and desired characteristics of the nonwoven. A plurality of fibers, from natural to synthetic, may be used for manufacture of vertically lapped nonwovens. The nonwoven can include combinations of two or more different natural fibers; two or more different man-made synthetic fibers; blends containing one or more natural fibers and one or more man-made fibers. Exemplary fibers which can be used in the practice of the invention include but are not limited to: cotton, kapok, flax, ramie, kenaf, abaca, coir, hemp, jute, sisal, rayon, bamboo fiber, Tencel®, and Modal® fibers, glass fibers, basalt fibers, Kevlar® fibers, aramid fibers, polyester fibers (e.g., which can function both as a binder fiber but, depending on the polyester, as part of the nonwoven blend), wool (which may be obtained, for example, from one of the forty or more different breeds of sheep, and which currently exists in about two hundred types of varying grades), silk, rayon (a man-made fiber that may include viscose rayon and cuprammonium rayon), acetate (a man-made fiber), nylon (a man-made fiber), acrylic (a man-made fiber), polyester (a man-made fiber), triacetate (a man-made fiber), spandex (an elastomeric man-made fiber such as Lycra®), polyolefin/polypropylene (man-made olefin fibers), microfibers and microdeniers, lyocell (a man-made fiber), vegetable fiber (a textile fiber of vegetable origin, such as cotton, kapok, jute, ramie, polylactic acid (PLA) or flax), vinyl fiber (a manufactured fiber), alpaca, angora, carbon fiber (suitable for textile use); (t) glass fiber (suitable for textile use), raffia, ramie, vinyon fiber (a manufactured fiber), Vectran® fibers (manufactured fiber spun from Celanese Vectra® liquid crystal polymer), and waste fiber. Fibers are commercially available from sources known by those of skill in the art, for example, E. I. Du Pont de Nemours & Company, Inc. (Wilmington, Del.), American Viscose Company (Markus Hook, Pa.), Teijin Frontier Co., Ltd. (Osaka, Japan), Tintoria Piana USA (Cartersville, Ga.), and Celanese Corporation (Charlotte, N.C.).

Exemplary types of polyesters which may be used in the practice of the invention include, but are not limited to, PET (polyethylene terephthalate), PTT (polytrimethylene terephthalate), and PBT (polybuthylene terephthalate). Additional examples of polyesters include, but are not limited to, 15 denier by 51 mm hollow PET, 15 denier by 51 mm solid PET, 12 denier by 64 mm PET made by Teijin, 6 denier by 64 mm PET made by Teijin, 6 denier by 51 mm sheath/core elastomeric binder with an elastomeric sheath that melts at 160° C. and a PBT core, 10 denier by 51 mm sheath/core high temperature binder with a sheath coPET that melts at 180° C. and a core PET.

Examples of compatible polymers include, but are not limited to, polyesters such as PET, PBT, PTT, and PCT.

Nonwovens useful in the practice of the invention can be formed using composite fibers, sometimes referred to as sheath-core fibers. Binder fibers used to produce nonwovens useful in the practice of this invention include sheath-core fibers, where the sheath is polyester or some other low melting temperature material.

As described above, the vertically lapped structural layer may comprise a combination of staple and binder fibers, such as a polyester staple fiber (optionally, a hollow conjugate fiber) and a polyester binder fiber. The binder fibers have a melting temperature that is below the melting or decomposition temperature of the one or more other fibers, e.g., binder fibers typically have a melting temperature of 80-200° C. (polyesters are typical examples of binder fibers used in the production of nonwovens (examples of elastic polyester binder fibers include ELK®, E-PLEX®, and EMF type high elastic LMF are commercially available from Teijin Limited, Toray Chemical Korea Inc., and Huvis Corporation, respectively)). Once the binder fibers are melted, they will generally track along the outsides of the one or more other fibers, and, on cooling, will harden to produce the nonwoven which is essentially a mass of the one or more other fibers with adjacent fibers held together at various locations throughout the nonwoven by binder material which results from melting and re-hardening of the binder fibers. These nonwovens are often referred to as thermobonded nonwovens. The vertically lapped structural layer may have 60-80% by weight binder material, with 20-40% by weight staple fibers. In some embodiments, the length of the staple fibers may be from 45-75 mm, e.g. 50-55 mm. The weight of the fabric may be between 500-1500 GSM. The loft may be from 5-90 mm.

The nonwoven layers described herein can be formed using fibers that are treated with chemicals (e.g., dyes (for coloring of some or all of the fibers), fire retardant chemicals (e.g., phosphates, sulfates, silicates, etc.), scents (perfumes, etc.), topical additives such as phase change material particles, talc, carbon nanotubes, etc.). Alternatively, a plurality of chemicals (e.g., dyes, scents, fire retardant chemicals, addition of microparticles, etc.) may be used to treat the nonwoven after completion of the final assembly of a structure.

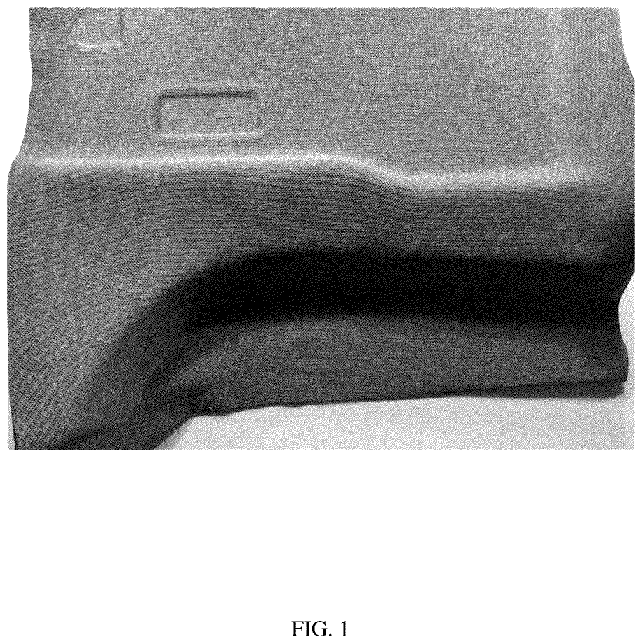

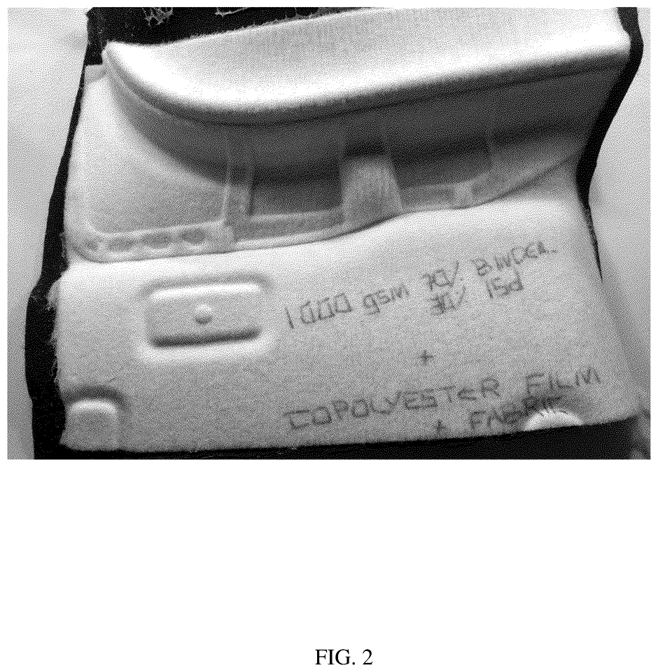

In some embodiments, at least one of the first surface and the second surface of the vertically lapped polymer material is molded to include one or more structural features that project from the first surface and/or the second surface so that the vertically lapped polymer material with the adhered sheet has a three dimensional configuration, e.g. as shown in FIGS. 1-2. The first and second surface may have the same structural features, different structural features, or a combination of the same and different structural features. The structural features may provide stiffness, designs for aesthetics, or allow for connection/attachment to components in, for example, an automobile roof or door, etc.

The product may further comprise at least one sheet 1 of a same polymer or a compatible polymer to the vertically lapped first polymer fibers adhered to at least one of the first surface and the second surface of the vertically lapped polymer material. The sheet does not comprise vertically lapped fibers. Suitable polymers and compatible polymers are described above in reference to the vertically lapped layer.

In some embodiments, the product further comprises a second vertically lapped layer arranged between the first vertically lapped polymer material and the at least one sheet. Suitable polymers and compatible polymers are described above in reference to the first vertically lapped layer. The second vertically lapped layer may be of an equal or lower density than the first vertically lapped layer and thus suitable as a soft touch layer, e.g. for a soft touch headliner. The second vertically lapped layer may have 15-75% by weight binder material, with 25-85% by weight staple fibers. In some embodiments, the staple fibers may have a length of 45-75 mm, e.g. 60-65 mm. In some embodiments, the staple fibers of the second vertically lapped layer are longer than the staple fibers of the first vertically lapped layer. The weight of the fabric may be between 50-500 GSM. The loft may be from 5-30 mm.

The product layers may have a varying height/thickness suitable for the desired application, e.g. as a headliner, doorliner, or trunkliner for a car. For example, each layer may have a height/thickness within the range of 0.1 to 2 inches.

In some embodiments, a thermo-adhesive film is arranged at one or more surfaces of the layers. The adhesive layer may comprise the same polymer or a compatible polymer to the vertically lapped layer. For example, the adhesive layer may include, but is not limited to, Protechnic YR8 adhesive web, Protechnic YF8 adhesive web, etc. In some embodiments, the liner, panel, or component does not have an adhesive layer. In some embodiments, an adhesive layer is arranged only between the structural vertically lapped layer and the sheet.

Various methods may be utilized to alter the surface esthetics of the nonwoven. For example, the surface can be made “brighter” or “duller” in appearance using different molding techniques. Alternatively, the surface may include a pattern of “brighter” or “duller” regions (e.g., a checkerboard pattern or other pattern). Also, the surface may be made “fluffier”, or to present a pattern with fluffier portions and less fluffy portions.

Methods for manufacturing the recyclable liner, panel, or component comprise heating the vertically lapped polymer material and the optional at least one sheet of a same polymer or a compatible polymer; and compressing the vertically lapped polymer material and the at least one sheet of a same polymer or a compatible polymer within a mold having a first tool surface and a second tool surface. At least one of the first tool surface and the second tool surface may have a three dimensional configuration that is imparted on at least one of the first surface and the second surface of the vertically lapped polymer material.

The material may be heated, e.g. in an oven, to a temperature no less than the melting point of the binder used in the nonwoven. The material is heated at or above the activation temperature of the binder, e.g. 80-200° C. or higher, for a time sufficient to melt the binder. After heating, the material is placed in a mold comprising an upper tool and a lower tool which will close on the material. The upper and lower tool may be formed from various metals and metal alloys including, but not limited to aluminum, chrome plated carbon steel, and stainless steel. The material surface that touches the top tool is referred to herein as the “A side” while the opposite side is referred to as the “B side”. The surface appearance and/or texture of the molded part can be influenced by the following process methods:
1. Having one of the tool surfaces hot while the other is cold
2. Having both tool surfaces cold
3. Having both tool surfaces hot
4. Having one of the tool surfaces polished while the other is not polished
5. Having both tool surfaces polished
6. Having one tool surface with a directional gradient to its polished state (from rough to extremely polished) while the other is not polished
7. Having both tool surfaces with a directional gradient to its polished state
8. Having one tool surface machined with a repeating or non-repeating pattern while the other does not have a pattern
9. Having both tool surfaces machined with a repeating or non-repeating pattern
10. Applying localized hot air to the demolded part on a specific surface to affect the part's localized surface finish
11. Having one or both tool surfaces with localized different surface temperatures
12. Molding a substrate with localized mass density variations to induce localized surface finish variations to the molded part
13. Molding multiple substrates with “tongue in groove” in a fashion to create a molded part that has a planned void without having to cut any material out to create that void
14. Molding a substrate made with fibers that possess optical brightener
15. Any combination of the above items

In some embodiments, the molded part can be back injected with polyester in some applications so as to meet structural stiffness requirements.

When molding with a cold top and bottom tool (i.e. a tool at ambient or room temperature), both A and B sides have a more dull appearance. However, a cold bottom tool and a hot top tool (i.e. the tool was heated to at least the activation temperature of the binder), the A side will appear shinier (e.g., measured brightness of 60 or greater using the CIE whiteness test) whereas the B side will remain dull. Hence a heated tool, regardless of nonwoven used, will provide a shinier or brighter surface. In some embodiments, the top tool is heated to give a shiny or brighter A surface which is viewed by passengers in a vehicle. The bottom portion of the mold may be at a lower or ambient temperature to provide a dull B surface which is not visible to the passengers in a vehicle. In some embodiments, one or both of the first tool surface and the second tool surface are heated prior to the compressing step. In some embodiments, at least one of the first tool surface and the second tool surface have different surface temperatures across the surface prior to the compressing step. For example, half of the surface may be heated while the other half is at an ambient temperature. Alternatively, the surface may have a plurality of zones, e.g. forming a checkerboard or other pattern, with different temperatures.

In some embodiments, the method further comprises applying heat to a portion of at least one of the first surface and the second surface of the vertically lapped polymer material after the compressing step.

The surface finish of the top and bottom tool can also affect brightness. In particular, the brightness of the A or B side may be increased by utilizing a more polished tool surface. A less polished or rougher surface provides a more dull appearance. In some embodiments, one or both of the first tool surface and the second tool surface are polished prior to the compressing step. In some embodiments, one or both of the first tool surface and the second tool surface are polished along a gradient from less polished to more polished prior to the compressing step. In some embodiments, the surface may have a plurality of zones, e.g. forming a checkerboard or other pattern, with different degrees of smoothness/roughness.

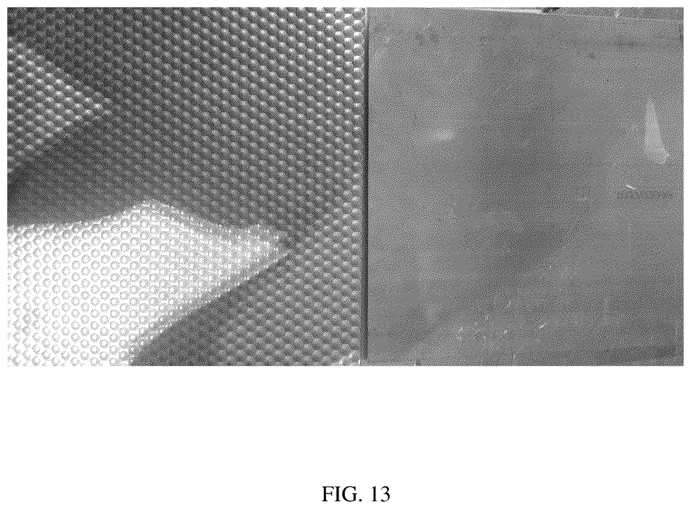

In an example embodiment, the mold contains a dual zoned top tool, e.g., one half heated and one half ambient temperature (or in a checkerboard or other pattern with multiple zones, or a pattern which provides for, for example, a logo of the automobile maker in a heated section and the remainder in a non-heated or ambient section, etc.). For example, in a dual zoned top tool, the gradient from hot side to cool side would create the gradient in final part surface finish that passengers find esthetically interesting: over the driver the headliner could be a bright finish while going toward the back passengers the headliner could be dull, almost textile like. FIG. 13 shows an exemplary top tool having a heated pattern surface on the left and an ambient temperature smooth plate on the right. This top tool may be used with an ambient bottom tool to provide a patterned, brighter, left side of the surface facing some automobile passengers, and a duller, unpatterned right side of the surface facing other automobile passengers. It is understood that the tools can take any shape depending on the desired end product.

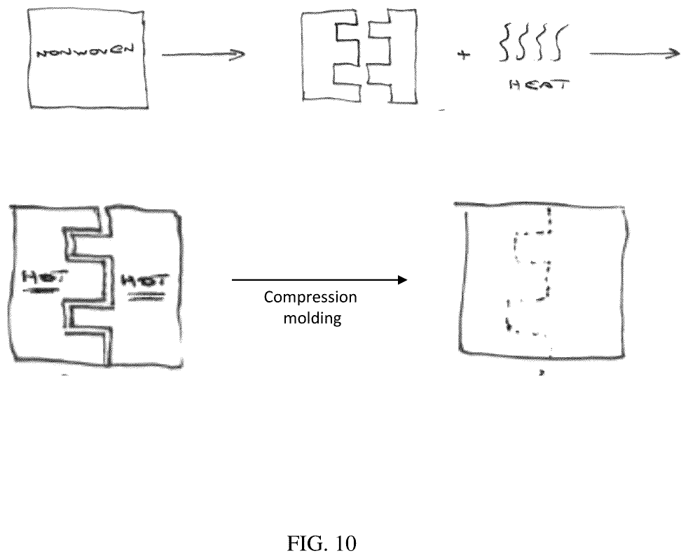

In some embodiments, the vertically lapped polymer material and the at least one sheet of a same polymer or a compatible polymer are each formed as two or more parts connectable via a three dimensional configuration before the heating step. During or after the heating step, the two or more parts may be connected. For example, with reference to FIG. 10, the nonwoven may be formed as separate parts which have a complementary tongue and groove configuration. During or after the heating step, the parts are placed together along the tongue and groove configuration and placed into the mold which solidifies the connection. When compressing the material, the nonwoven flares out at the tongue and groove joint and helps bond the tongue and groove pieces together. Additional strength or rigidity may be obtained by putting over the tongue and groove area on both sides a layer of scrim or other suitable material.

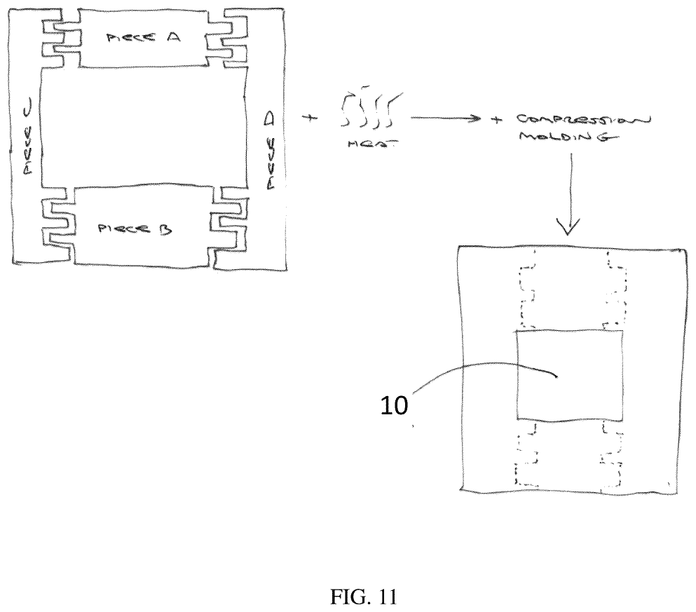

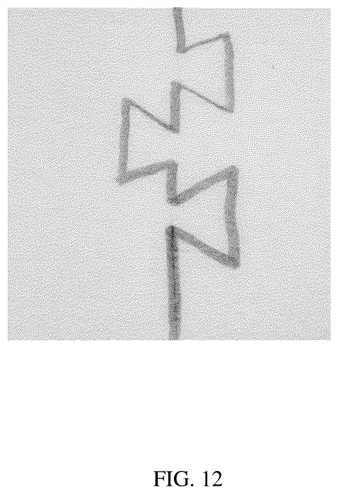

With reference to FIG. 11, the tongue and groove configuration may be used to create a part that has a void 10 within it, e.g. for a vehicle sunroof. This process allows for the creation of the void 10 without having to cut out the open space, e.g. using a die. The tool surfaces of the mold may be modified as discussed herein (i.e. heated, polished, patterned, etc.) to impart the desired esthetics. Any suitable design for the tongue and groove configuration may be utilized. Another exemplary design is shown in FIG. 12.

In some embodiments, optically bright fibers may be incorporated in the vertically lapped polymer material and/or sheet which will provide a brighter surface appearance after molding. Optical brighteners or optical whiteners are known in the art and are added to give a ‘white’ look to the final fabric. The brightener compound (e.g. about 150-250 ppm) may be added along with TiO₂ and catalyst before the start of the polymerization. In some embodiments, fibers having a measured brightness of 60 or more are used.

In some embodiments, the nonwoven surface to be viewed on the interior of a vehicle can be post treated with heated air or a brush to change its appearance. This may be accomplished by completely removing the nonwoven article from the mold, or by only removing the top tool surface such that the nonwoven article remains in the bottom portion of the mold. Heat treatment can be accomplished using, for example, an industrial robot arm. The robot arm may comprise a flexible duct that blows hot air. The robot arm may be controlled to blow hot air on specific spots of the exposed surface. The hot air would then relax locally the fiber and enable it to locally “de-densify” and hence show a different brightness, luster, or texture.

A brush treatment can be performed by, for example, taking the molded nonwoven article (as mentioned above) and applying a motorized brush vacuum head to various surface areas to aesthetically modify all or a portion of the surface which will be viewed by passengers. In one application, brushes would abrade the surface of the fabric and create a local brightness, luster or texture, for example.

The liners, panels, and components described herein may have applications in various vehicles, e.g. automobiles, trucks, boats, planes, trains, etc. In particularly preferred embodiments, the liners, panels, and components are environmentally-friendly as the parts are recyclable since each layer may be composed of the same or compatible fibers, e.g. the same or compatible polyesters.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided it is understood that each intervening value, to the tenth of the unit of the lower limit unless the context clearly dictates otherwise, between the upper and lower limit of that range and any other stated or intervening value in that state range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Example 1. Hard Surface Headliner

An embodiment is comprised of 100% polyester and has three primary layers:
1) Polyester substrate
2) Polyester film
3) Polyester fabric

The polyester substrate is a vertically lapped nonwoven structure with the following characteristics:
70%, 10 denier, high temperature, polyester binder fiber
30%, 15-denier, polyester staple fiber
1000-gsm
25-mm loft

The polyester film may be a co-polyester thermo-adhesive film, such as those made by 2Gamma.

The polyester fabric may be a multi-layer assembly of a knitted polyester fabric that is backed with a polyester, needle-punched nonwoven, typical to those used in automotive applications.

The materials are layered into a sandwich configuration and placed inside an IR oven or other suitable means to preheat the assembly.

Next, the preheated, multi-layer sandwich is placed into a cold, compression mold where the assembly is compressed into a consolidated assembly that is about 3-5-mm thick.

The mold has intended design features that impart necessary design features, mounting locations for other parts/subassemblies and structural properties to ensure that the 100% polyester assembly meets the rigors of current testing standards including high temperature (95° C.) sag testing as well as other related automotive standards.

The resultant parts show a high degree of stiffness, a high level of detail with respect to the various geometry features, no wrinkling and with sufficient adhesion of the polyester substrate to the polyester fabric assembly as is shown in FIGS. 1 and 2.

The layup of the materials is as shown in FIG. 3A with the following reference numerals:
1—multi-layer polyester fabric
2—thermo-adhesive polyester film
3b—high density, vertically lapped nonwoven
   (i.e., structural layer)

### Example 2. Soft Touch Surface Headliner

Example 1 provides a means for realizing a hard surface headliner; however, the need for a soft touch headliner that complies with the expectations of the ELA Directive is also needed. A dual density, layered approach is offered with a VLAP board having a high-density structural layer and a lower-density layer to address the soft-touch design requirement. The dual-density part would be co-molded with a fabric layer and then the low-density side of the assembly would be subsequently reanimated to provide resiliency and the soft touch attribute.

The embodiment may be comprised of 100% polyester and has three primary components:
1) Polyester substrate
2) Polyester film
3) Polyester fabric

The polyester substrate for this application is a dual-layer, dual-density, vertically lapped nonwoven structure with the following characteristics:

### Layer #1—High-Density Vertically Lapped Structural Layer

70%, 10 denier, high temperature, polyester binder fiber
30%, 15 denier, polyester staple fiber
1000 gsm
25 mm loft

### Layer #2—Low-Density Vertically Lapped Soft Touch Layer

70-80%, 3-15 denier, polyester staple fiber, may or may not be hollow conjugate fiber
20-30%, 6 denier, polyester elastomeric binder fiber
150-300 gsm
10-15 mm loft

The polyester film is a co-polyester thermo-adhesive film, such as those made by 2Gamma and is used to adhere the fabric layer to the substrate layer. In some applications, the polyester film may be used to assemble the high-density, vertically lapped structural layer to the low-density, vertically lapped soft touch layer. Alternatively, the layers may be joined without the use of adhesive film, relying on the binder fibers to adhere the two layers to one another.

The polyester fabric is a multi-layer assembly of a knitted polyester fabric that is backed with a polyester, needle-punched nonwoven, typical to those used in automotive applications.

The materials are layered into a sandwich configuration and placed inside an IR oven or other suitable means to preheat the assembly. The layup of the materials is as shown in FIG. 3B with the following reference numerals:
1—multi-layer polyester fabric
2—thermo-adhesive polyester film
3a—low density, vertically lapped nonwoven
   (i.e., soft touch layer)
3b—high density, vertically lapped nonwoven
   (i.e., structural layer)
3—dual-layer, dual-density nonwoven assembly with optional thermo-adhesive polyester film

Next, the preheated, multi-layer sandwich is placed into a cold, compression mold where the assembly is compressed into a consolidated assembly that is about 4-7-mm thick.

The mold has intended design features that impart necessary design features, mounting locations for other parts/subassemblies and structural properties to ensure that the 100% polyester assembly meets the rigors of current testing standards including high temperature (95° C.) sag testing as well as other related automotive standards.

Heat is then applied to the fabric side of the cold compression molded, single polymer assembly, enabling the low-density, vertically lapped nonwoven soft touch layer to expand. The expansion of the low-density layer (i.e., reamination), caused when the binder fiber of the vertically lapped nonwoven melts, provides the soft-touch property.

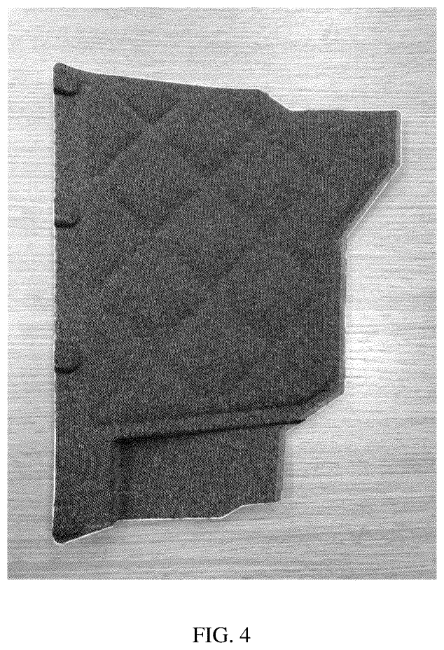

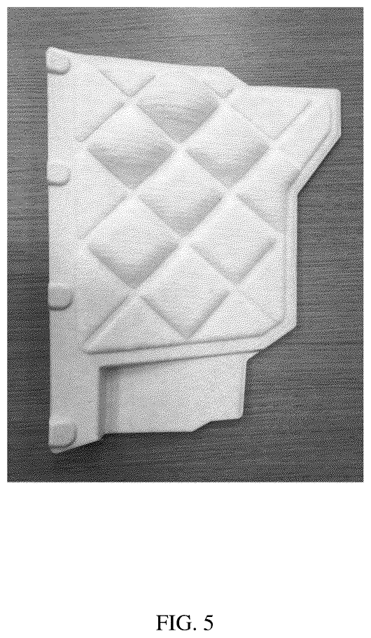

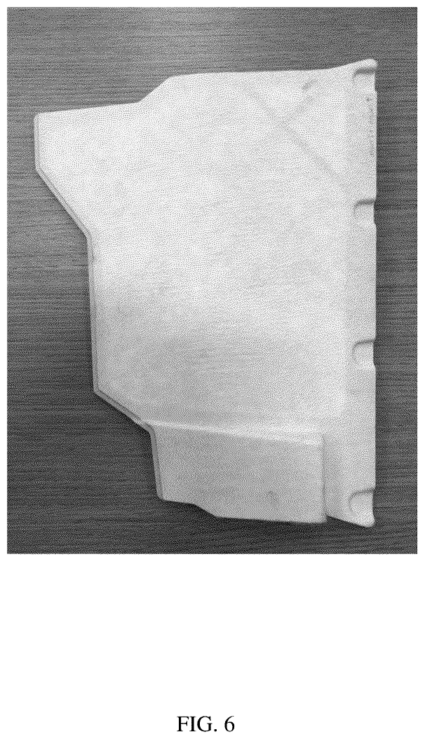

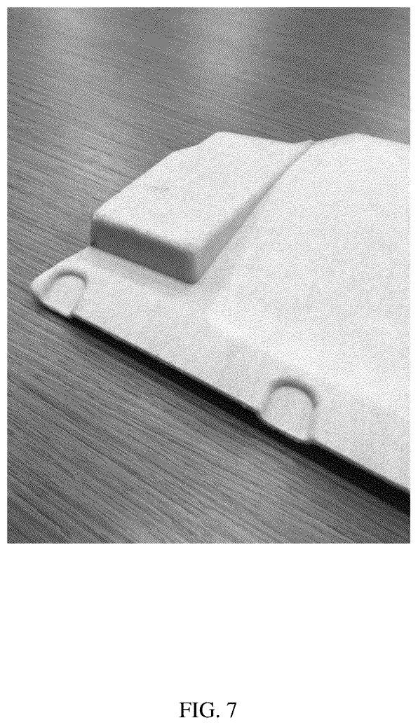

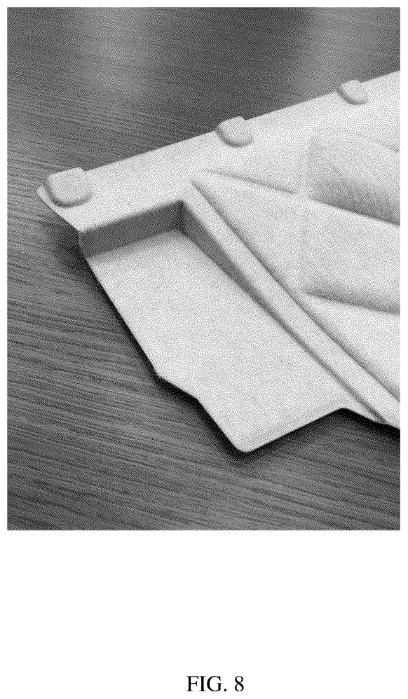

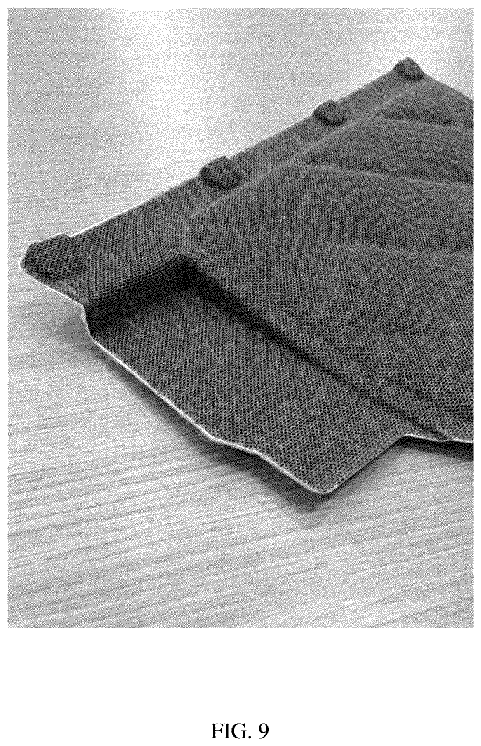

The resultant parts show a high degree of stiffness, a high level of detail with respect to the various geometry features, no wrinkling and with sufficient adhesion of the polyester substrate to the polyester fabric assembly. Moreover, the assembly exhibits a soft touch property as required in certain applications. FIGS. 4-9 show various headliner fabrications. Adhesion of the fabric was successful without the need for the adhesive film. The process remained the same with a preheating of the sandwich and a cold compression molding.

### Example 3. Dual Surface Finish on the Same Part

Two plates were combined to mold the A side of a nonwoven: a flat dull finish aluminum plate that was cold, and a flat chrome plated finely polished plate that was heated in the oven at 180° C. for 25 min. The nonwoven was heated at 180° C. for 5 min. After heating, the nonwoven was placed on a cold bottom plate. The upper plate containing the cold aluminum on one half and the heated, polished chrome on the other half was placed on top of the nonwoven. The nonwoven was compressed for 5 minutes and then demolded. The cold plated aluminum side was dull while the hot chrome plated side was bright.

### Example 4. Headliner with Reduced Fiber Disentanglement

Some nonwoven blends and constructions may have issues over time such as sagging, deformation of the molded geometry, and reanimation, all due to high temperature exposure (e.g., 95° ° C. for 30 to 45 min).

Experimental testing has proved that with a hot mold, using a cold or hot substrate, one can obtain a part that does not sag, deform, change shape, or reanimate more than 1.5 mm in any direction, under the same environmental conditions (e.g., 95° C. for 30 to 45 min). The high temperature exposure test (e.g., 95° ° C. for 30 to 45 min) is a quick surrogate test for the more formal 5-day exposure test which involves a temperature and humidity cycle scenario.

Conditions affecting the result include: the binder, binder content, staple fiber, staple fiber content, volumetric density, loft, and molding characteristics. An exemplary configuration is shown in Table 1.

TABLE 1

| | | | | Loft |
|---|---|---|---|---|
| Headliner | Blend | | BW | (initial) |
| B-surface | 70% | 10 d, high-temp polyester binder | 1000 | 32-45 |
| (back) | 30% | 15 d, 51 mm cut, polyester staple | gsm | mm |
| A-surface | 55% | 4 d, high-temp polyester binder | 200 | 15 |
| (front) | 45% | 6 d, 64 mm cut, polyester staple | gsm | mm |

The A-surface remains soft, cushiony, and not subject to fiber disentanglement (also known as pilling). Further, the change in staple fiber cut length from 51 mm to 64 mm is believed to be a primary contributor to addressing pilling concerns.

### Example 5. Soft Touch Headliner with Optional Fabric Layer

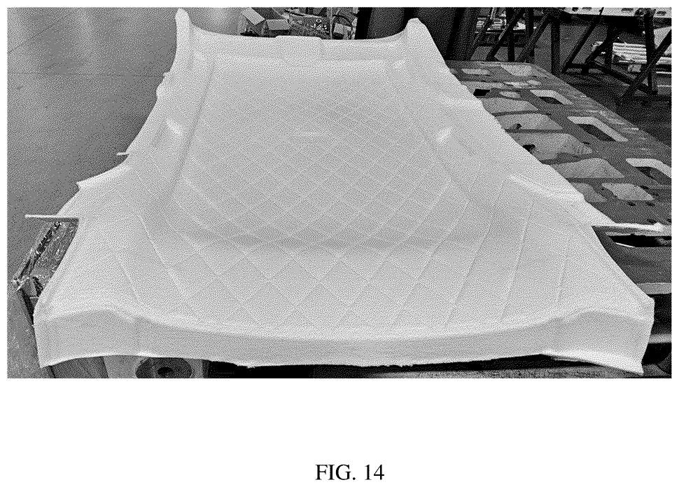

With reference to FIG. 14, a soft touch headliner without a fabric layer was made as described herein. The B side of the headliner comprises 1000 gsm vertically lapped polyester fibers. The A side of the headliner comprises 1000 gsm vertically lapped nonwoven comprising 70%, 12 denier Teijin polyester staple fiber and 30%, 6 denier Teijin elastomeric binder fiber. The A side nonwoven provides a “soft touch”, i.e. the pillow surfaces are not hard but can be pushed in similar to a cushion. The exemplary headliner was successfully produced using either a heated substrate and a cold mold or a cold substrate and a heated mold. Use of both a heated substrate and a heated mold is expected to be successful as well.

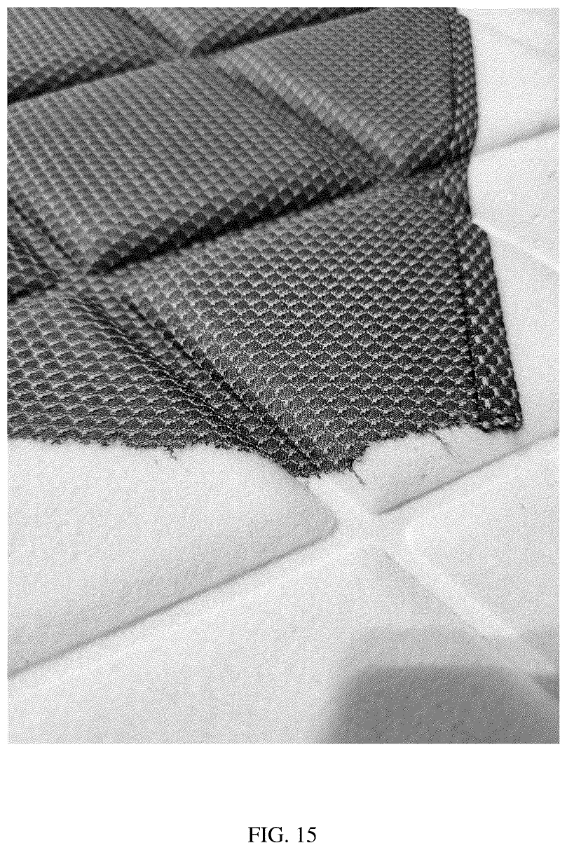

FIG. 15 shows a soft touch headliner made from the same materials as shown in FIG. 14, however, the A side is partially covered with a fabric layer.

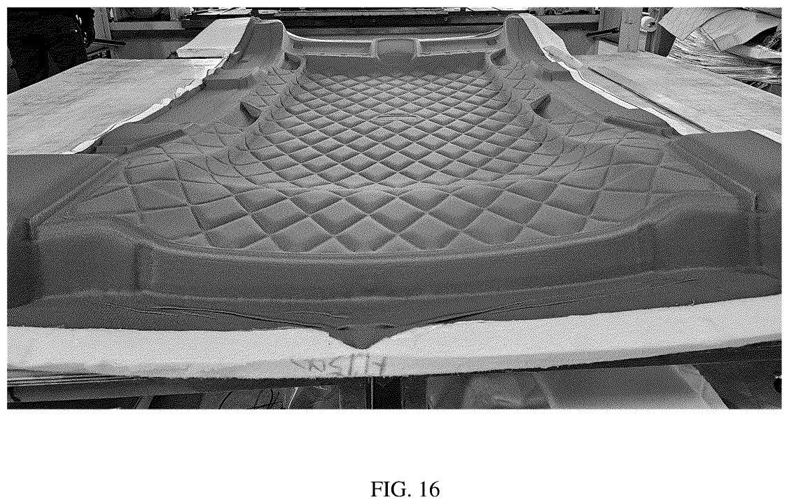

FIG. 16 shows a soft touch headliner made from the same materials as shown in FIG. 14, however, a fabric layer completely covers the A side. The fabric is attached to the A side via a Protechnic adhesive web.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

What is claimed is:

1. A recyclable liner, panel or component, comprising:
a vertically lapped polymer material constructed from at least vertically lapped first polymer fibers, wherein the vertically lapped polymer material comprises a first surface and a second surface; and
optionally at least one sheet of a same polymer or a compatible polymer to the vertically lapped first polymer fibers adjacent to at least one of the first surface and the second surface of the vertically lapped polymer material,
wherein at least one of the first surface and the second surface of the vertically lapped polymer material is molded to include one or more structural features that project from the first surface and/or the second surface so that the vertically lapped polymer material with the adhered sheet has a three dimensional configuration.

2. The recyclable liner, panel or component of claim 1, wherein said vertically lapped first polymer fibers and the sheet of the same polymer or the compatible polymer are both polyesters.

3. The recyclable liner, panel, or component of claim 2, where the polyesters are the same polyester.

4. The recyclable liner, panel, or component of claim 1, wherein the one or more structural features are configured for attachment to another part.

5. The recyclable liner, panel, or component of claim 1, wherein the one or more structural features are on both the first and the second surface of the vertically lapped polymer material.

6. The recyclable liner, panel, or component of claim 1, wherein the one or more structural features are project from only the first surface or the second surface of the vertically lapped polymer material.

7. The recyclable liner, panel, or component of claim 1, wherein the three dimensional configuration forms at least part of a headliner for an automobile.

8. The recyclable liner, panel, or component of claim 7, wherein the headliner is a hard touch headliner.

9. The recyclable liner, panel, or component of claim 7, wherein the headliner is a soft touch head liner and further comprises a second vertically lapped polymer material constructed from at least vertically lapped second polymer fibers, wherein the second vertically lapped polymer material has a lower density than the first vertically lapped polymer material and is arranged between the first vertically lapped polymer material and the at least one sheet.

10. The recyclable liner, panel, or component of claim 7, wherein the headliner is a soft touch head liner and further comprises a second vertically lapped polymer material constructed from at least vertically lapped second polymer fibers, wherein the second vertically lapped polymer material has an equal density as the first vertically lapped polymer material and is arranged between the first vertically lapped polymer material and the at least one sheet.

11. The recyclable liner, panel, or component of claim 1, wherein the three dimensional configuration forms at least part of an interior door for an automobile.

12. The recyclable liner, panel, or component of claim 1, wherein the three dimensional configuration forms at least part of an interior member of an automobile, truck, plane, train, or boat.

13. The recyclable liner, panel, or component of claim 1, wherein the at least one sheet is adhered to the at least one of the first surface and/or the second surface of the vertically lapped polymer material using an adhesive film, scrim, net, or web comprising the same polymer or the compatible polymer to the first polymer fibers.

14. The recyclable liner, panel, or component of claim 1, wherein the at least one sheet is adhered to the at least one of the first surface and the second surface of the vertically lapped polymer without an adhesive film, scrim, net or web.

15. A method of manufacturing the recyclable liner, panel, or component of claim 1, comprising
heating the vertically lapped polymer material and optionally the at least one sheet of a same polymer or a compatible polymer; and
compressing the vertically lapped polymer material and optionally the at least one sheet of a same polymer or a compatible polymer within a mold having a first tool surface and a second tool surface, wherein at least one of the first tool surface and the second tool surface has a three dimensional configuration that is imparted on at least one of the first surface and the second surface of the vertically lapped polymer material.

16. The method of claim 15, wherein one of the first tool surface and the second tool surface is heated prior to the compressing step.

17. The method of claim 15, wherein both the first tool surface and the second tool surface are heated prior to the compressing step.

18. The method of claim 15, wherein one of the first tool surface and the second tool surface is polished prior to the compressing step.

19. The method of claim 15, wherein both the first tool surface and the second tool surface are polished prior to the compressing step.

20. The method of claim 15, wherein one of the first tool surface and the second tool surface is polished along a gradient from less polished to more polished prior to the compressing step.

21. The method of claim 15, wherein both the first tool surface and the second tool surface are polished along a gradient from less polished to more polished prior to the compressing step.

22. The method of claim 15, wherein one of the first tool surface and the second tool surface contains a repeating or non-repeating pattern.

23. The method of claim 15, wherein both of the first tool surface and the second tool surface contain a repeating or non-repeating pattern.

24. The method of claim 15, further comprising applying heat to a portion of at least one of the first surface and the second surface of the vertically lapped polymer material after the compressing step.

25. The method of claim 15, wherein at least one of the first tool surface and the second tool surface have different surface temperatures across the surface prior to the compressing step.

26. The method of claim 15, wherein at least one of the vertically lapped polymer material and the at least one sheet of a same polymer or a compatible polymer have mass density variations within the material or sheet.

27. The method of claim 15, wherein the vertically lapped polymer material and the at least one sheet of a same polymer or a compatible polymer are each formed as two or more parts connectable via a three dimensional configuration before the heating step and wherein the two or more parts are connected during or after the heating step.
